(19) United States
(12) Patent Application Publication
(10) Pub. No.: US 2006/0218132 A1
(43) Pub. Date: Sep. 28, 2006

(54) Predictive data mining SQL functions (operators)

(75) Inventors: Denis Mukhin, Marlborough, MA (US); Boriana L. Milenova, Reading, MA (US); Peter J. Stengard, St. Pete Beach, FL (US); Ramkumar Krishnan, Nashua, NH (US); Marcos M. Campos, Cambridge, MA (US); Ari Wolfe Mozes, Lexington, MA (US)

Correspondence Address: Swidler Berlin LLP, Suite 300, 3000 K Street, N.W., Washington, DC, 20007, US

(73) Assignee: Oracle International Corporation

(21) Appl. No.: 11/088,858

(22) Filed: Mar. 25, 2005

(51) Int. Cl. G06F 17/30

(52) U.S. Cl. 707/4

(57) ABSTRACT

A system and computer program product provides data mining model deployment (scoring) functionality as a family of SQL functions (operators). A database management system comprises a processor operable to execute computer program instructions, a memory operable to store computer program instructions executable by the processor, and computer program instructions stored in the memory and executable to implement a plurality of database query language statements, each statement operable to cause a data mining function to be performed.

### BACKGROUND OF THE INVENTION

1. Field of the Invention

The present invention relates to a system and computer program product that provides data mining model deployment (scoring) functionality as a family of SQL functions (operators).

2. Description of the Related Art

Data mining is a technique by which hidden patterns may be found in a group of data. True data mining doesn't just change the presentation of data, but actually discovers previously unknown relationships among the data. Data mining is typically implemented as software in or in association with database systems. There are two major components (and a few minor components) of the data mining process: building models and deploying models. The concept of deployment in predictive data mining refers to the application of a model for prediction or classification to new data. After a satisfactory model or set of models has been identified (built or trained) for a particular application, those models are deployed (scored) so that predictions or predicted classifications can quickly be obtained for new data. For example, a credit card company may want to deploy a trained model or set of models (e.g., neural networks, meta-learner) to quickly identify transactions which have a high probability of being fraudulent. Many conventional data mining systems deploy data mining models through proprietary Application Programming Interfaces (APIs). Many other conventional data mining systems perform scoring outside of the database by transferring the data and the result in and out of database.

Typical database management systems use query languages, such as Structured Query Language (SQL), to create, modify, and query databases. The use of APIs to deploy data mining models in database management systems causes significant additional complexity for the user of such systems for data mining. This is because the API is an additional set of functions that must be used in addition to the SQL statements. In addition, this division causes data mining model scoring performance to be relatively slow, due to the overhead involved.

It is common practice that data mining models are built within a testing environment by data mining analysts. In many businesses, it is then crucial to deploy these models into a production environment where they are used to score unknown data. This deployment process needs to include the model and all transformations that were applied to the original input data for the build operation. Conventionally, the user must keep track of all needed transformations and ensure that they are properly applied at deployment. This can be a difficult and time-consuming task.

A need arises for a data mining technique that provides greater ease of deployment, flexibility, and performance than using an API to deploy data mining functions in a database management system.

### SUMMARY OF THE INVENTION

The present invention provides data mining model deployment (scoring) functionality as a family of SQL functions (operators). These new data mining functions allow the user to apply models within the context of arbitrary SQL statements. This has many advantages. For example, deployment of models within the context of existing applications becomes straightforward, since existing SQL statements can be easily enhanced with these new functions. Scoring performance is greatly improved, especially in single row scoring cases, as advantage can be taken of existing query execution functionality. Pipelining of results involving data mining predictions is also enabled, which has many benefits, including the ability to return some results quickly to the end user.

In one embodiment of the present invention, a database management system comprises a processor operable to execute computer program instructions, a memory operable to store computer program instructions executable by the processor, and computer program instructions stored in the memory and executable to implement a plurality of database query language statements, each statement operable to cause a data mining function to be performed.

In one aspect of the present invention, the database query language statements are structured query language statements containing data mining functions. Data mining functions performed by the structured query language statements comprise scoring an arbitrary data mining model. The data mining model used by the structured query language statement can be either built prior to the invocation of the structured query language statement or build during the execution of the structured query language statement. The structured query language statements containing data mining functions comprise at least one of a function specifying a data mining prediction to be made, a function specifying that a probability for a data mining prediction is to be determined, a function specifying that a cost for a data mining prediction is to be determined, a function specifying a set of data mining predictions is to be generated, a function specifying that details of a data mining prediction are to be obtained, a function specifying that a confidence interval for a data mining prediction is to be determined, a function specifying a cluster identifier to be obtained, a function specifying that a confidence of membership of an input row in a given cluster is to be determined, a function specifying that a collection containing all clusters that a given row belongs to is to be generated, a function specifying that a feature with a highest value is to be determined, a function specifying that a value of a given feature is to be determined, and a function specifying that a collection of all features is to be generated. The structured query language statements containing data mining functions are further operable to perform data transformations to be performed before the data mining function is performed. The data mining function comprise a model specification allowing either a pre-build model to be used or a new model to be build during the execution of the data mining function. The data mining functions comprise a cost clause allowing a model cost or a user-provided cost to be specified. Each structured query language statement that is operable to cause a data mining function to be performed may be used similarly to any other structured query language statement. Each data mining function may appear in a select list, where clause, group by clause, having clause or order by clause of a SELECT statement, INSERT, DELETE, UPDATE statements, triggers, etc. (or anywhere a value expression is allowed in a structure query language statement)

### BRIEF DESCRIPTION OF THE DRAWINGS

Further features and advantages of the invention can be ascertained from the following detailed description that is provided in connection with the drawings described below:

FIG. 1 is an exemplary block diagram of a system in which the present invention may be implemented.

FIG. 2 is an example of a software architecture of a data mining block shown in FIG. 1.

FIG. 3 is an exemplary block diagram of a database management system, in which the present invention may be implemented.

### DETAILED DESCRIPTION OF THE PREFERRED EMBODIMENTS

When building a data mining model, a user specifies a set of predictors (sometimes called attributes). For supervised models (like classification and regression), the user also has to specify a target. For example, a user may want to predict customer income level (the target) given other customer attributes (for example, customer year of birth and customer gender). For an unsupervised model (like clustering), the user only needs to provide the set of predictors—no target should be specified.

The simplest type of supervised model is a single-target binary classification. An example of such a model would be one which represents whether or not a customer is likely to chum. It is binary since there are two possible outcomes: YES or NO. A data mining model might predict that a particular customer will churn (a YES value) with a probability of 85% (meaning there is a 15% chance that the customer will not chum). A single-target multi-class classification would have more than 2 possible predicted values. For example, the desired prediction may be an income range, such as LOW, MED, or HIGH. As with the binary case, there will be a best prediction corresponding to the target value of highest probability. It may be that a particular customer is likely to have LOW income, and associate a probability of 45% with that prediction. Even though this probability is less than 50%, it may be the most likely prediction (perhaps MED has a 40% probability and HIGH has a 15% probability). This is different from the binary case because, in this case, best prediction can have a probability below 50%. The basic piece of information produced when applying a classification model to a given row is the best prediction and its associated probability.

As implied by the name, a prediction is not absolute—it is an educated guess as to the best class that a given row belongs to. All of the possible target classes have some probability of being the correct prediction for a given row. In the real-world, the cost of misclassification may be different for different target classes. For example, it may be that incorrectly predicting someone as having HIGH income when they have MED income is much worse than incorrectly predicting someone as having MED income when they actually have HIGH. These costs will impact what is considered the best prediction, and must be taken into account when ordering the possible predicted target values.

In a single-target regression model, the target is numerical. For example, it may be desired to predict someone's income given other attributes about them. The confidence associated with this prediction would be a measure of expected error in the prediction, for example: expected_value +/−confidence_interval.

Unlike classification and regression, a clustering model is unsupervised and has no target attribute. The goal is to segment the incoming data into clusters, where the records in a cluster are alike in some way. Applying a cluster model to a given row returns the cluster ID, and the corresponding probability would be a probabilistic measure of the row's membership in the cluster.

Feature extraction/Factorization (for example Non-negative matrix factorization and Principal Component Analysis) maps input attributes to a new, usually much smaller set of features. One usage of FE could be to reduce the set of attributes to a smaller set, and then build another model on the reduced set of attributes.

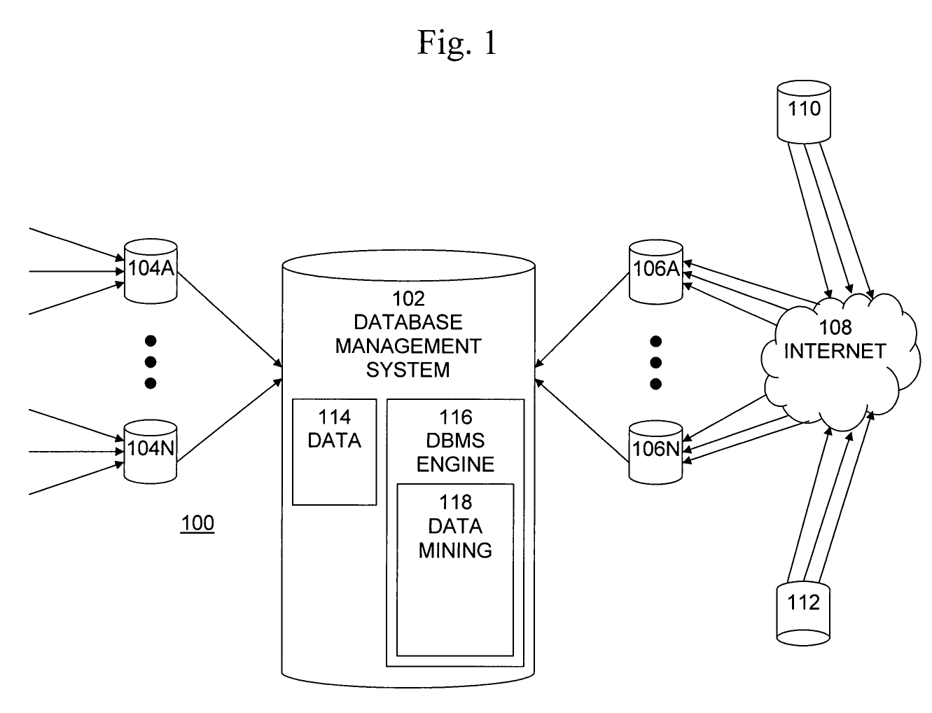

An example of a system 100 in which the present invention may be implemented is shown in FIG. 1. As shown in FIG. 1, system 100 includes a database management system 102 that is connected to a variety of sources of data. For example, system 102 may be connected to a plurality of internal or proprietary data sources, such as systems 104A-104N. Systems 104A-104N may be any type of data source, warehouse, or repository, including those that are not publicly accessible. Examples of such systems include inventory control systems, accounting systems, scheduling systems, etc. System 102 may also be connected to a plurality of proprietary data sources that are accessible in some way over the Internet 108. Such systems include systems 106A-106N, shown in FIG. 1. Systems 106A-106N may be publicly accessible over the Internet 108, they may be privately accessible using a secure connection technology, or they may be both publicly and privately accessible. System 102 may also be connected to other systems over the Internet 108. For example, system 110 may be privately accessible to system 102 over the Internet 108 using a secure connection, while system 112 may be publicly accessible over the Internet 108.

In the embodiment shown in FIG. 1, data mining functionality is included in database management system (DBMS) 102. DBMS 102 includes two main components, data 114, and DBMS engine 116. Data 114 includes data, typically arranged as a plurality of data tables, as well as indexes and other structures that facilitate access to the data. DBMS engine 116 typically includes software that receives and processes queries of the database, obtains data satisfying the queries, and generates and transmits responses to the queries. DBMS engine 116 also includes data mining block 118, which provides DBMS engine 116 with the capability to obtain data and perform data mining processing on that data, so as to respond to requests for data mining processed data from one or more users.

Data mining block 118 includes predictive data mining SQL functions 120, which implement the present invention. These predictive data mining SQL functions 120 provide scoring functionality as a family of SQL functions (operators). These new data mining functions allow the user to apply models within the context of arbitrary SQL statements.

Providing a SQL built-in function for data mining prediction has many benefits. Deployment of models within the context of existing applications becomes straightforward since existing SQL statements can be easily enhanced with these new functions. Scoring performance is greatly improved, especially in single row scoring cases, as we can take advantage of existing query execution functionality (such as shared cursors to cache the model metadata). Pipelining of results involving data mining predictions is also enabled, which has many benefits, including the ability to return some results quickly to the end user.

One advantage of the present invention is to make data mining deployment very simple for the novice user. The PREDICTION function, in conjunction with wildcard input for predictor values, means that requesting the best prediction is very simple—PREDICTION(model USING *). The only thing the user needs is a model (which has probably been built by a more seasoned data mining user) and a dataset (which has been prepared to match the model build data) to apply the model to. Similarly, the CLUSTER_ID and FEATURE_ID function is straightforward. Some of the other functions, such as PREDICTION_SET and PREDICTION_DETAILS, allow more advanced analysis of the results of applying a predictive model to an input row. The advanced user can post-process this information in more complex ways, producing a result tailored to their needs. Functions like PREDICTION_PROBABILITY and PREDICTION_COST allow an advanced user to access some of the more important information in a simpler and more performant manner than going through the _SET and _DETAILS routines.

Another advantage of the SQL built-in model scoring functions is that the necessary transformations can be embedded as SQL expressions and natively processed by the database. In the above example, assume that the value of birth was normalized by dividing by 2000 when the model was originally built. In that case, the apply data should be similarly transformed as follows: select cust_first_name, cust_last_name, PREDICTION(classmodel USING cust_year_of_birth/2000 AS birth, cust_gender) as my_pred from customers;

This transformation does not impact the rest of the query, which means that the prediction function can be easily embedded in pre-existing complex SQL statements without having to stage and pre-process the scoring data to be in sync with the data used to build the model.

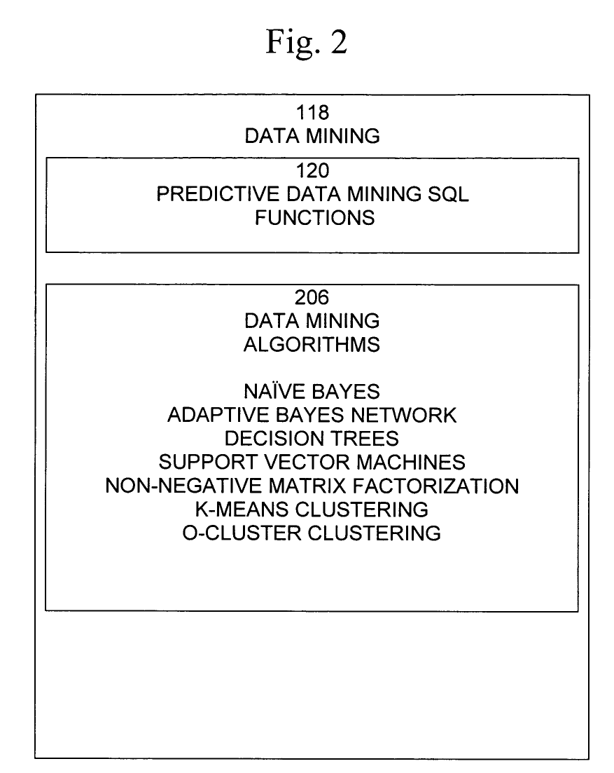

An example of a software architecture of data mining block 118 is shown in FIG. 2. As shown in this example, data mining block 118 includes predictive data mining SQL functions 202 and data mining algorithms 206. Data mining algorithms 206, for example, include classification algorithms such as NB, SVM, regression algorithm such as SVM, clustering algorithm such as K-Means and feature extraction algorithm such as NMF.

Examples of new query statements that implement the present invention are described below. For the examples below, it is assumed that the customers table is being used and that the following models have been built:

a classification model to predict cust_income_level, called classmodel

a regression model to predict cust_credit_limit, called regrmodel

a probabilistic clustering model, called clusmodel

a non-negative matrix factorization model, called nmfmodel

An example of data mining functions syntax

<prediction function> ::=

PREDICTION <left paren> <prediction operands> <right paren>

<prediction operands> ::=

<model name> [ COST <cost matrix specification> ]

USING [ <mining attribute list> ]

<model name> ::=

<qualified name>

<mining attribute list> ::=

<asterisk>

| <mining attribute sublist>

[ { <comma> <mining attribute sublist> } ... ]

<mining attribute sublist> ::=

<derived mining attribute>

| <qualifier> <period> <asterisk>

<derived mining attribute> ::=

<value expression> [ <mining attribute as clause> ]

<mining attribute as clause> ::=

[ AS ] <mining attribute name>

<mining attribute name> ::=

<identifier>

The values in the mining attribute list are mapped to the predictors that were provided when the model was built. The name of the predictor must match the one used during the build operation for it to be considered the same predictor.

If more predictors are provided in the mining attribute list than are predictors used by the model, then these extra expressions will be ignored and the operation will proceed as if those extra expressions were never specified.

If fewer predictors are provided than were used during the build, then the operation will proceed with the subset that was provided and predictions will be returned on a ‘best-effort’ basis. All types of models will return a result regardless of the number of predictors provided.

A cost matrix can be used both at model build and model score time. The purpose of a cost matrix is to add a weight for different types of errors to achieve a more desirable result. For example, by specifying COST MODEL, the user is indicating that the scoring should be performed by taking into account the cost matrix that was associated with the model at build time.

An example of the PREDICTION syntax is:

<prediction function> ::=

PREDICTION <left paren> <prediction operands> <right paren>

<prediction operands> ::=

<model name> [ COST <cost matrix specification> ]

USING [ <mining attribute list> ]

For classification models, this function returns the best prediction.

In the common case when no cost matrix is provided, the best prediction would be the target class with the highest probability.

In the case where cost matrix is specified, the best prediction would be the target class with the lowest cost.

For regression models, this function returns the expected value.

The datatype that this function returns is dependent on the target value type used during build. PREDICTION is only valid for classification and regression models.

### Examples

select cust_first_name, cust_last_name, PREDICTION(classmodel COST MODEL USING cust_year_of_birth AS birth, cust_gender) as best_pred from customers;
select cust_id, PREDICTION(sh.regrmodel USING c.*) as best_pred from customers c;

An example of the PREDICTION_PROBABILITY syntax is:

<prediction probability function> ::=

PREDICTION_PROBABILITY <left paren>

<prediction probability operands> <right paren>

<prediction probability operands> ::=

<model name> [ <comma> <class value> ]

USING [ <mining attribute list> ]

<class value> ::=

<value expression>

The purpose of this function is to return a probability for a given prediction.

If the optional class parameter is not specified, then this function would return the probability associated with the best prediction (and would commonly be used in conjunction with the PREDICTION function to return the best prediction value/probability pair). The best prediction is defined to be the class with the highest probability.

If the optional parameter is specified, it will return the probability for the specified class, which will represent the probability associated with choosing the given target class value.

This function returns a number. PREDICTION_PROBABILITY is only valid for classification models.

### Examples

select cust_id,
PREDICTION(classmodel USING *) best_pred,
PREDICTION_PROBABILITY(classmodel using c.*) best_prob from
customers c;
select
PREDICTION_PROBABILITY(classmodel, ‘E: 90,000 - 109,999’
USING
cust_year_of_birth AS birth) my_prob
from customers;

An example of the PREDICTION_COST syntax is:

<prediction cost function> ::=

PREDICTION_COST <left paren>

<prediction cost operands> <right paren>

<prediction cost operands> ::=

<model name> [ <comma> <class value> ]

COST <cost matrix specification>
USING [ <mining attribute list> ]

The purpose of this function is to return a measure of cost for a given prediction. If the optional class parameter is not specified, then this function would return the cost associated with the best prediction (and would commonly be used in conjunction with the PREDICTION function to return the best prediction value/cost pair). If the optional parameter is specified, it will return the cost for the specified class.

This function returns a number. PREDICTION_COST is only valid for classification models.

### Examples

select cust_id,
PREDICTION(classmodel COST MODEL USING *) best_pred,
PREDICTION_PROBABILITY(classmodel, PREDICTION(classmodel
COST MODEL USING *) USING *) best_prob,
PREDICTION_COST(classmodel COST MODEL using *) best_cost
from
customers c;
select
PREDICTION_COST(classmodel, ‘E: 90,000 - 109,999’ COST
MODEL
USING cust_year_of_birth AS birth) my_cost
from customers;

An example of the PREDICTION_SET syntax is:

<prediction set function> ::=

PREDICTION_SET <left paren>

<prediction set operands> <right paren>

<prediction set operands> ::=

<model name> [ <comma> <top N> [ <comma> <cutoff> ] ]

[ COST <cost matrix specification> ]
USING [ <mining attribute list> ]

<top N> ::=

<value expression>

<cutoff> ::=

<value expression>

This function returns a collection of objects. The collection contains all classes in a multi-class classification scenario. The elements are returned in order of from best prediction to worst prediction.

In the default case where cost matrix is not specified, each object in the collection is a pair of scalars containing <prediction value, prediction probability>. The datatype of the prediction value is dependent on the target datatype. The datatype of the prediction probability is a number.

In the case where a cost matrix is specified, each object in the collection would be a triplet of scalars containing <prediction value, prediction probability, prediction cost>. The first two datatypes are as before, and the datatype of prediction cost is a number.

The optional top N and cutoff arguments are used to restrict the set of predicted values. When no cost matrix is specified, these arguments refer to the prediction probability. In this way, top N is used to restrict the returned target classes to the N having the highest probability. The cutoff argument is used to restrict the returned target classes to those which have a probability greater than or equal to the specified cutoff.

When a cost matrix is specified, the top N and cutoff terms are treated with respect to the prediction cost, not the prediction probability. This means that top N will restrict the result to the target classes having the N lowest costs. The cutoff argument would be used to restrict the returned target classes to those which have a cost less than or equal to the specified cutoff.

If specified, top N must be an integer greater than zero (or set to null if the user only wants to specify cutoff).

The top N and cutoff parameters can be used together to restrict the returned predictions to only those that are in the bestN and have a probability (or cost when a cost matrix is specified) surpassing the threshold. To filter only by cutoff (not bestN), the user should specify NULL for bestN and the desired threshold for the cutoff parameter.

PREDICTION_SET is only valid for classification models.

### Examples

select t.cust_id, s.prediction, s.probability from (select cust_id,
PREDICTION_SET(classmodel USING *) pset from customers c) t,
TABLE
(t.pset) s;
create type pred_type as object (pred varchar2(4000), prob
number, cost number); /
create type pred_set_type as varray(5) of pred_type;
select c.cust_id, cast (PREDICTION_SET(classmodel, 5 COST
MODEL USING
c.*) as pred_set_type) my_pred_set from customers c;

An example of the PREDICTION_DETAILS syntax is:

<prediction detail function> ::=

PREDICTION_DETAILS <left paren>

<prediction detail operands> <right paren>

<prediction detail operands> ::=

<model name>

USING [ <mining attribute list> ]

This function returns an XML string containing model specific information relating to the scoring of the input row. For example, for decision tree models this function provides at minimum Rule IDs.

### Examples

select cust_id,
PREDICTION(classmodel USING *) best_pred,
PREDICTION_DETAILS(classmodel USING *) best_pred_details from
customers c;

An example of the CLUSTER_ID syntax is:

<cluster function> ::=

CLUSTER_ID <left paren>

<cluster operands> <right paren>

<cluster operands> ::=

<model name>

USING [ <mining attribute list> ]

This function returns the cluster identifier of the predicted cluster with the highest probability for the given set of predictors. This function returns a number.

### Examples

select cust_first_name, cust_last_name,
CLUSTER_ID(clusmodel USING cust_year_of_birth AS birth,
cust_gender) as
best_clus from customers;

An example of the CLUSTER_PROBABILITY syntax is:

<cluster probability function> ::=

CLUSTER_PROBABILITY <left paren>

<cluster probability operands> <right paren>

<cluster probability operands> ::=

<model name> [ <comma> <cluster id> ]

USING [ <mining attribute list> ]

<cluster id> ::=

<value expression>

The purpose of this function is to return a measure of the degree (confidence) of membership of an input row in a given cluster. If the optional cluster id parameter is not specified, then this function would return the probability associated with the best predicted cluster (and would commonly be used in conjunction with the CLUSTER_ID function to return the best predicted cluster ID/probability pair). If the optional parameter is specified, it will return the probability for the specified cluster id. This function returns a number.

### Examples

select cust_id,
CLUSTER_ID(clusmodel USING c.*) best_clus,
CLUSTER_PROBABILITY(clusmodel using c.*) best_prob
from customers c;

An example of the CLUSTER SET syntax is:

<cluster set function> ::=

CLUSTER_SET <left paren>

<cluster set operands> <right paren>

<cluster set operands> ::=

<model name> [ <comma> <top N> [ <comma> <cutoff> ] ]

USING [ <mining attribute list> ]

This function returns a collection of objects. This collection contains all possible clusters that the given row belongs to. Each object in the collection is a pair of scalars containing <cluster Id, cluster probability>.

The optional top N argument is used to restrict the set of predicted clusters to those which have one of the top N probability values. If top N is not specified (or set to null), then all clusters will be returned in the collection.

The optional cutoff argument is used to restrict the returned clusters to those which have a probability greater than or equal to the specified cutoff. top N and cutoff can be used together to restrict the returned clusters to only those that are in the top N and have a probability that passes the threshold. To filter only by cutoff (not top N), the user should specify NULL for top N and the desired cutoff for the second parameter.

### Examples

select t.cust_id, s.cluster id, s.probability from
(select cust_id, CLUSTER_SET(clusmodel USING *) pset from
customers c) t,

TABLE (t.pset) s;

An example of the FEATURE_ID syntax is:

<feature function> ::=

FEATURE_ID <left paren>

<feature operands> <right paren>

<feature operands> ::=

<model name>

USING [ <mining attribute list> ]

The purpose of this function is to return the feature with the highest value (coefficient). This function returns a number.

### Examples

select cust_id, FEATURE_ID(nmfmodel USING *) best_feature
from customers;

An example of the FEATURE_VALUE syntax is:

<feature value function> ::=

FEATURE_VALUE <left paren>

<feature value operands> <right paren>

<feature value operands> ::=

<model name> [ <comma> <feature id> ]

USING [ <mining attribute list> ]

<feature id> ::=

<value expression>

The purpose of this function is to return the value of a given feature. If no feature is provided, then this function will return the highest feature value and will be commonly used in conjunction with FEATURE to get the largest feature/value combination. This function returns a number.

For the example below, let us suppose that we ran NMF on our input data and then fed the resulting two features into a decision tree build. When we wanted to score data using the decision tree model, the NMF model would play the role of preprocessing (transforming) the input data.

### Examples

select cust_id,

PREDICTION(classmodel USING

FEATURE_VALUE(nmfmodel, 1 USING *)
AS feature_1,
FEATURE_VALUE(nmfmodel, 2 USING *)
AS feature_2) best_pred

from customers;

An example of the FEATURE_SET syntax is:

<feature set function> ::=

FEATURE_SET <left paren>

<feature set operands> <right paren>

<feature set operands> ::=

<model name> [ <comma> <top N> [ <comma> <cutoff> ] ]
USING [ <mining attribute list> ]

This function returns a collection of objects. This collection contains all possible features. Each object in the collection is a pair of scalars containing <feature Id, feature value>.

The optional top N argument is used to restrict the set of features to those which have one of the top N values (if there is a tie at the Nth value, the server will still return only N values). If not specified, then all features will be returned in the collection. The optional cutoff argument will restrict the returned features to only those which have a feature value greater than or equal to the specified cutoff. To filter only by cutoff (not top N), the user should specify NULL for top N and the desired cutoff for the second parameter.

### Examples

select t.cust_id, s.feature id, s.value from
(select cust_id, FEATURE_SET(nmfmodel USING *) pset from
customers c) t,

TABLE (t.pset) s;

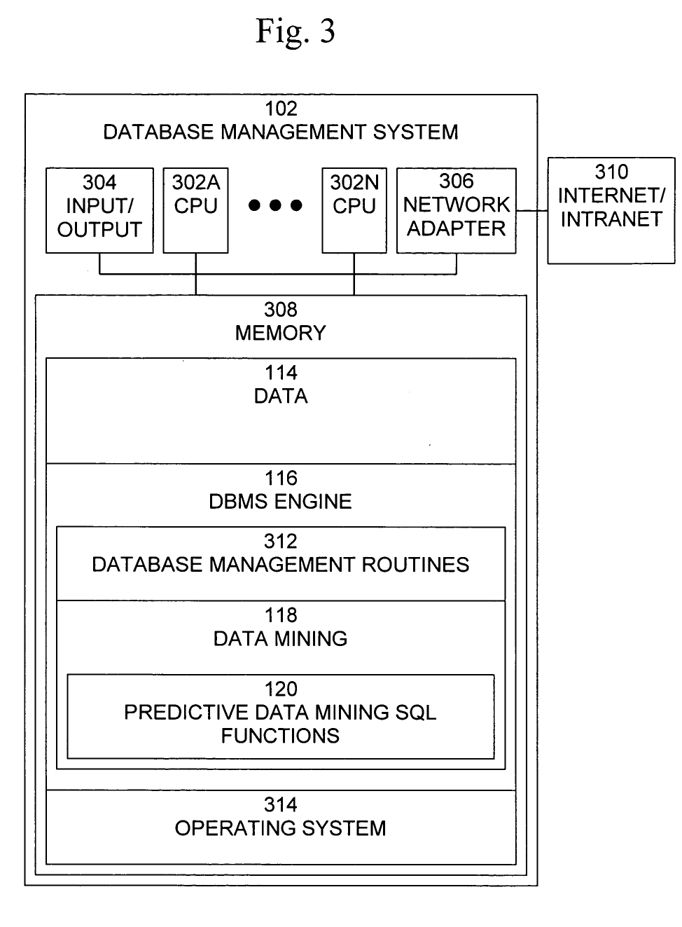

An exemplary block diagram of a database management system 102, shown in FIG. 1, is shown in FIG. 3. System 102 is typically a programmed general-purpose computer system, such as a personal computer, workstation, server system, and minicomputer or mainframe computer. System 102 includes one or more processors (CPUs) 302A-302N, input/output circuitry 304, network adapter 306, and memory 308. CPUs 302A-302N execute program instructions in order to carry out the functions of the present invention. Typically, CPUs 302A-302N are one or more microprocessors, such as an INTEL PENTIUM® processor. FIG. 3 illustrates an embodiment in which System 102 is implemented as a single multi-processor computer system, in which multiple processors 302A-302N share system resources, such as memory 308, input/output circuitry 304, and network adapter 306. However, the present invention also contemplates embodiments in which System 102 is implemented as a plurality of networked computer systems, which may be single-processor computer systems, multi-processor computer systems, or a mix thereof.

Input/output circuitry 304 provides the capability to input data to, or output data from, database/System 102. For example, input/output circuitry may include input devices, such as keyboards, mice, touchpads, trackballs, scanners, etc., output devices, such as video adapters, monitors, printers, etc., and input/output devices, such as, modems, etc. Network adapter 306 interfaces database/System 102 with Internet/intranet 310. Internet/intranet 310 may include one or more standard local area network (LAN) or wide area network (WAN), such as Ethernet, Token Ring, the Internet, or a private or proprietary LAN/WAN.

Memory 308 stores program instructions that are executed by, and data that are used and processed by, CPU 302 to perform the functions of system 102. Memory 308 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 308 varies depending upon the function that system 102 is programmed to perform. One of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 3, memory 308 includes data 114, and database management system (DBMS) engine 116. Data 114 includes data, typically arranged as a plurality of data tables, as well as indexes and other structures that facilitate access to the data. DBMS engine 116 includes database management routines, which is software that receives and processes queries of the database, obtains data satisfying the queries, and generates and transmits responses to the queries. DBMS engine 116 also includes data mining block 118, which provides DBMS engine 116 with the capability to obtain data and perform data mining processing on that data, so as to respond to requests for data mining processed data from one or more users.

Data mining block 118 includes predictive data mining SQL functions 120, which implement the present invention. These predictive data mining SQL functions 120 provide scoring functionality as a family of SQL functions (operators). These new data mining functions allow the user to apply models within the context of arbitrary SQL statements.

As shown in FIG. 3, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A database management system comprising:
a processor operable to execute computer program instructions;
a memory operable to store computer program instructions executable by the processor; and
computer program instructions stored in the memory and executable to implement a plurality of database query language statements, each statement operable to cause data mining functions to be performed.

2. The system of claim 1, wherein the database query language statements are structured query language statements containing data mining functions.

3. The system of claim 2, wherein the data mining functions performed by the structured query language statements comprise scoring an arbitrary data mining model.

4. The system of claim 3, wherein the data mining model is built prior to the invocation of the structured query language statement that comprises scoring an arbitrary data mining model.

5. The system of claim 3, wherein the data mining model is built during execution of the structured query language statement that comprises scoring an arbitrary data mining model.

6. The system of claim 2, wherein the structured query language statements comprise at least one of:
a function specifying a data mining prediction to be made;
a function specifying that a probability for a data mining prediction is to be determined;
a function specifying that a cost for a data mining prediction is to be determined;
a function specifying a set of data mining predictions is to be generated;
a function specifying that details of a data mining prediction are to be obtained;
a function specifying that a confidence interval for a data mining prediction is to be determined,
a function specifying a cluster identifier to be obtained;
a function specifying that a confidence of membership of an input row in a given cluster is to be determined;
a function specifying that a collection containing all clusters that a given row belongs to is to be generated;
a function specifying that a feature with a highest value is to be determined;
a function specifying that a value of a given feature is to be determined; and
a function specifying that a collection of all features is to be generated.

7. The system of claim 3, wherein the structured query language statements are further operable to perform data transformations before the data mining function is performed.

8. The system of claim 3, wherein the data mining function comprises a cost clause allowing a model cost or a user-provided cost to be specified.

9. The system of claim 2, wherein each structured query language statement that is operable to cause a data mining function to be performed may be used similarly to any other structured query language statement.

10. The system of claim 2, wherein each data mining function may appear in a select list, a group by clause, an order by clause, a where clause of a SELECT statement, INSERT, DELETE, UPDATE statements, triggers.

11. The system of claim 2, wherein each data mining function may appear anywhere a value expression is allowed in a structured query language statement.

12. A computer program product for performing data mining is a database management system, comprising:
a computer readable medium;
computer program instructions, recorded on the computer readable medium, executable by a processor, for implementing a plurality of database query language statements, each statement operable to cause data mining functions to be performed.

13. The computer program product of claim 12, wherein the database query language statements are structured query language statements containing data mining functions.

14. The system of claim 13, wherein the data mining functions performed by the structured query language statements comprise scoring an arbitrary data mining model.

15. The system of claim 14, wherein the data mining model is built prior to the invocation of the structured query language statement that comprises scoring an arbitrary data mining model.

16. The system of claim 14, wherein the data mining model is built during execution of the structured query language statement that comprises scoring an arbitrary data mining model.

17. The computer program product of claim 13, wherein the structured query language statements comprise at least one of:
a function specifying a data mining prediction to be made;
a function specifying that a probability for a data mining prediction is to be determined;
a function specifying that a cost for a data mining prediction is to be determined;
a function specifying a set of data mining predictions is to be generated;
a function specifying that details of a data mining prediction are to be obtained;
a function specifying that a confidence interval for a data mining prediction is to be determined,
a function specifying a cluster identifier to be obtained;
a function specifying that a confidence of membership of an input row in a given cluster is to be determined;
a function specifying that a collection containing all clusters that a given row belongs to is to be generated;
a function specifying that a feature with a highest value is to be determined;
a function specifying that a value of a given feature is to be determined; and
a function specifying that a collection of all features is to be generated.

18. The computer program product of claim 17, wherein the structured query language statements are further operable to perform data transformations before the data mining function is performed.

19. The system of claim 14, wherein the data mining function comprises a cost clause allowing a model cost or a user-provided cost to be specified.

20. The system of claim 13, wherein each structured query language statement that is operable to cause a data mining function to be performed may be used similarly to any other structured query language statement.

21. The system of claim 13, wherein each structured query language statement that is operable to cause a data mining function to be performed may appear in a select list, a group by clause, an order by clause, a where clause of a SELECT statement, INSERT, DELETE, UPDATE statements, triggers.

22. The system of claim 13, wherein each structured query language statement that is operable to cause a data mining function to be performed may appear anywhere a value expression is allowed in a structure query language statement.
